(19) United States
(12) Patent Application Publication
(10) Pub. No.: US 2024/0361747 A1
(43) Pub. Date: Oct. 31, 2024

(54) SYSTEMS AND METHODS FOR AUTOMATIC GENERATION AND OPTIMIZATION OF MACHINING STRATEGIES

(71) Applicant: Toolpath Labs, Inc., Peachtree City, GA (US)

(72) Inventors: Justin S. Gray, Solon, OH (US); Fei Shen, Charlotte, NJ (US); Charles A. Mader, Mississauga (CA); Mark A. Powell, Peachtree City, GA (US)

(21) Appl. No.: 18/647,626

(22) Filed: Apr. 26, 2024

Related U.S. Application Data
(60) Provisional application No. 63/462,466, filed on Apr. 27, 2023.

(51) Int. Cl. G05B 19/4093

(52) U.S. Cl. CPC G05B 19/40937

(57) ABSTRACT

An automated machining system comprising a CNC machine and a processor configured to automatically identify one or more features to be machined into a workpiece to form a part; determine a set of tools suitable for performing a removal operation associated with machining each feature; identify those tools necessary for performing roughing and finishing removal operations for each feature; generate various sequences of removal operations suitable for machining all of the one or more features; calculate a cost of performing each removal operation sequence; determine which of the removal operations sequences is optimal; generate corresponding toolpaths for machining the features into the workpiece; and provide instructions to the CNC machine for automatically implementing the optimal removal operation sequence and corresponding toolpaths to machine the features into the workpiece to form the part. A system for automatic generation and optimization of machining strategies. A system for automatic generation of toolpaths.

### CROSS-REFERENCE TO RELATED APPLICATION

This application claims the benefit of and priority to U.S. Provisional Application No. 63/462,466, filed Apr. 27, 2023, which is hereby incorporated herein by reference in its entirety for all purposes.

### TECHNICAL FIELD

The present disclosure is directed to systems and methods for automatically generating a machining strategy and, in particular, automatically identifying a set of tools and corresponding removal operations suitable for machining various features into a workpiece, automatically determining an optimal combination and sequencing of removal operations, and automatically generating corresponding toolpaths, in each case, using approaches configured to permit various operations to be performed in parallel for maximizing computational efficiency and time required.

### BACKGROUND

Currently, the process of creating a machining strategy for a computer numerical control (CNC) machining tool is typically performed by a skilled machinist or computer-aided manufacturing (CAM) programmer, using specialized CAM software. These manual processes can be very time consuming, requiring the CAM user to make dozens of decisions to specify every detail of the process, and perform dozens of separate actions to generate even simple programs for simple parts. These time-consuming processes tie up machinist resources, which can be particularly problematic in cases of low volume, high mix applications, such as prototyping.

### SUMMARY

The present disclosure is directed to systems and methods for automatically generating a machining strategy to be implemented by, e.g., CNC machining tools. The system and methods disclosed herein can identify features to be machined into the workpiece, identify a set of tools suitable for performing removal operations necessary to create those features, and automatically determine an optimal combination and sequencing of removal operations. Such approaches can be optimized towards a number of different factors, with minimizing the time required to machine all of the features into the workpiece often being a primary objective. A machinist can then either manually machine the workpiece by following the optimized machining strategy or provide an automated machining system with corresponding instructions (e.g., G code) for automated implementation to machine the features into the workpiece. The present disclosure is further directed to systems and methods for automatically generating toolpaths for corresponding removal operations in a parallel manner, thereby further improving computational efficiency and reducing time required to generate a machining strategy.

Systems and methods of the present disclosure do not merely automate known methods, but rather transform each unique machining scenario into a unique construct that can be solved using a variety of optimization methods. Critically, the construct accounts for the effects preceding removal operations may have on the cost of performing subsequent removal operations, thereby overcoming a challenge which would ordinarily preclude the use of certain optimization methods known in the art. Unlike existing CAM systems, which must work sequentially, dealing with each individual machining action in sequence, the present systems and methods may be configured to analyze all machining actions simultaneously. Further, in various embodiments, the present systems and methods can be configured to perform many operations in parallel, thereby reducing the overall time required to automatically determine an optimized machining strategy

### BRIEF DESCRIPTION OF THE DRAWINGS

FIG. 1 is a flow chart illustrating a representative embodiment of a method for automatically generating a machining strategy.

FIG. 2 is a CAD model depicting a representative workpiece according to an embodiment of the present disclosure.

FIG. 3 is a matrix identifying particular tools that may be suitable for performing removal operations 40 associated with machining each particular feature.

FIG. 4 illustrates a selection of terminal tools in accordance with an embodiment of the present disclosure.

FIG. 5A illustrates a matrix-based approach for identifying valid removal operation sequences in accordance with an embodiment of the present disclosure.

FIG. 5B illustrates an undirected graph corresponding to the matrix of FIG. 4.

FIG. 5C illustrates a directed graph corresponding to the ROS₁ shown in FIG. 5A.

FIGS. 6A-6C illustrate representative maximum removal volumes of different tools for a given feature.

FIGS. 7A-7C illustrate sequence-dependent nature of actual removal volumes for a given removal operation.

FIG. 8A is a table depicting the calculation of machining time for an example ROS₁ of FIG. 5A.

FIG. 8B is a table depicting the calculation of cost for an example ROS₁ of FIG. 5A.

FIG. 9 is a flow chart illustrating another representative embodiment of a method for automatically generating a machining strategy.

FIG. 10A illustrates a representative undirected graph analogous to the undirected graph of FIG. 5B.

FIG. 10B illustrates a representative directed graph analogous to the directed graph of FIG. 5C.

FIG. 11 is a flowchart depicting an existing approach for generating toolpaths.

FIG. 12 is a flow chart illustrating another representative embodiment of a method for automatically generating tool paths.

FIG. 13 is a representative system according to an embodiment.

### DETAILED DESCRIPTION

### Method 100 for Automatic Generation and Optimization of Removal Sequences

### High-Level Methodology

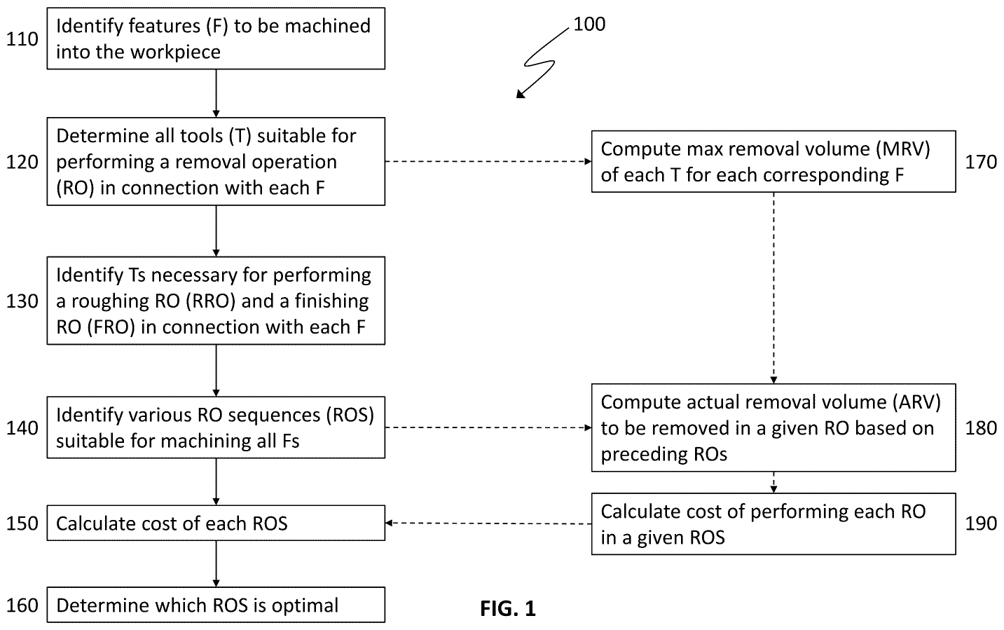

FIG. 1 is a flow chart illustrating a representative embodiment of method 100 for automatically generating a machining strategy 102. As used in the present disclosure, the term “machining strategy” means a sequence of actions (i.e., removal operations 40, as later defined) performed to machine a workpiece 10. Each removal operation 40 may utilize a specific tool 30, exercising a specific toolpath, with a specific feed/speed, on a specific part of the geometry (i.e., a feature 20). One or multiple removal operations 40 may be performed to create a particular feature 20. As used in the present disclosure, the term “toolpath” means a continuous sequence of points a single tool 30 will traverse during a single removal operation 40.

Method 100, in various embodiments, may comprise: (i) step 110 of identifying features (F) 20 to be machined into the workpiece 10; (ii) step 120 of determining all tools (T) 30 suitable for performing a removal operation (RO) 40 in connection with each feature 20; (iii) step 130 of identifying, from the set of tools 30 determined to be suitable for performing a removal operation 40, those tools 30 necessary for performing a roughing removal operation (RRO) 41 and a finishing removal operation (FRO) 42 in connection with each feature 20; (iv) step 140 of identifying various sequences 50 of removal operations 40 (ROS) suitable for machining all required features 20; (v) step 150 of calculating the cost of each removal operation sequence 50; and (vi) step 160 of determining, based on the calculated costs, which removal operation sequence 50 is optimal.

In various embodiments, the effect of preceding removal operations 40 on subsequent removal operations 40 in each removal operation sequence 50 may be accounted for when calculating the cost of each removal operation sequence. In particular, and as later described in more detail, this may be accomplished by determining the maximum removal volume (MRV) 43 achievable by the tool 30 used in any given removal operation 40 and then, for a given removal operation 40 in a removal operation sequence 50, subtracting the maximum removal volume 43 associated with each preceding removal operation 40 in the removal operation sequence 50. This, in effect, determines the actual removal volume (ARV) 44 left to be removed by the tool associated with the current removal operation 40 during the current removal operation. Actual removal volume 44 is typically a significant contributor to the cost of performing the current removal operation 40 and, as such, cost calculations reflect, in at least one aspect, the effect of having removed material during preceding removal operations 40. As later described in more detail, several other aspects of preceding removal operations 40 can also be determined and factored into subsequent removal operation 40 cost calculations.

In various embodiments, one or more steps of the method 100 can be performed in parallel to other steps, which can reduce overall computing time. As shown in FIG. 1, in a representative embodiment, steps associated with determining the maximum removal volume 43 (e.g., step 170) and actual removal volume 44 (e.g., step 180) associated with each removal operation 40 and the associated cost calculations for each removal operation 40 (e.g., step 190), can be performed in parallel to other steps of the method 100, as later described in more detail.

### Identifying Features 20 to be Machined in Workpiece 10

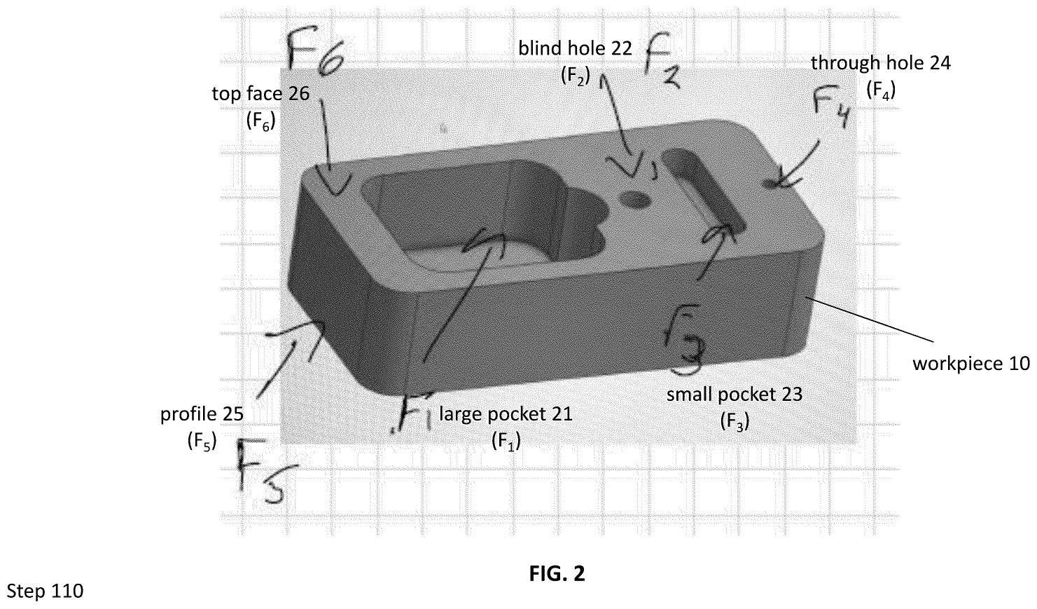

FIG. 2 is a CAD model depicting a representative workpiece 10 machined to include a variety of common features 20, including a large pocket 21, a blind hole 22, a small pocket 23, a through hole 24, a profile 25, and top face 26.

In various embodiments, method 100 may include identifying the particular features 20 included in such a CAD model. In a preferred embodiment, method 100 may be configured to automatically identify such features 20 without guidance or other input from a user of the system 300. For example, automatic detection of simple flat faces is a common feature in many existing computer aided manufacturing (CAM) systems. Some, such as Fusion 360 and Siemens NX, also offer the ability to detect simple pockets and holes as well. In academic literature, many papers present a wide range of feature identification approaches as well, including computer vision-based and attributed adjacency graph-based approaches. One of ordinary skill in the art will recognize various approaches for automatically identifying features 20 in a CAD model and the present disclosure is not intended to be limited to any particular approach.

The CAD model of FIG. 2 is intended to serve as an illustrative example for further explaining various concepts described throughout the present disclosure. The workpiece 10 and features 20 shown in FIG. 2, along with the associated tools 30, removal operations 40, and other concepts described with reference thereto throughout the present disclosure, are merely illustrative and as such it should be recognized that the present disclosure is not intended to be limited to developing a machining strategy 102 for any particular workpiece 10 or feature(s) 20, nor doing so with any particular features 20, tools 30, or other equipment described herein. One of ordinary skill in the art will recognize how to adapt the concepts described in the present disclosure to a variety of workpieces 10, features 20, tools 30, and other equipment without undue experimentation.

### Identifying Tools 30 Suitable for Corresponding Removal Operations 40

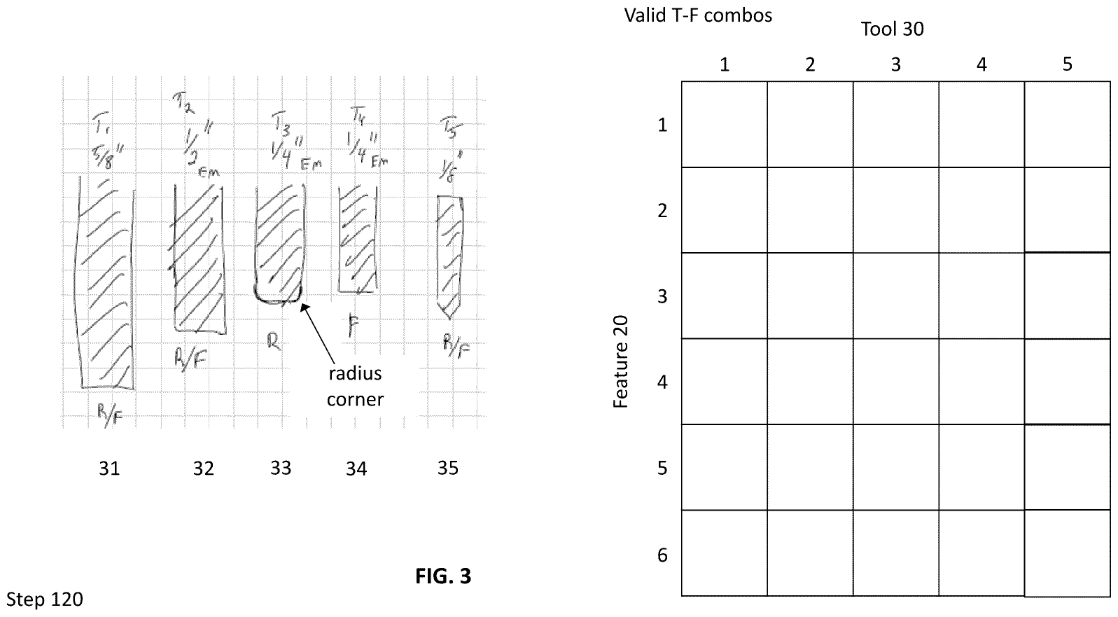

FIG. 3 is a representative matrix identifying particular tools 31, 32, 33, 34, 35 that may be suitable for performing removal operations 40 associated with machining each particular feature 20.

The set of tools 30 to draw from can vary from embodiment to embodiment. For example, in an embodiment, a user could identify a set of tools 30 he/she has on-hand (or some preferred subset thereof) such that the resulting machining strategy 102 is adapted to use only those readily available tools 30. In other embodiments, tools 30 could be selected from a predetermined catalog of tools 30, whether such catalog is stored on system 300, created by user, accessed from a third-party source, or otherwise. In one such embodiment, system 300 could be configured to facilitate the purchase and/or delivery of particular tools 30 to user from a third-party seller, thereby creating additional sources of revenue for the provider of the system 300 (e.g., direct sales if the provider is a seller of tools, or commissions paid to the provider by third-party sellers for such referrals). One of ordinary skill in the art will recognize that the particular source and composition of the catalog of tools 30 considered by the system is not intended to be a limiting factor in the present disclosure, but rather of import are the approaches disclosed herein for evaluating the suitability, capability, and performance of such tools 30 for potential removal operations 40 in connection with required features 20.

Geometric analysis can be used to determine the suitability of a particular tool 30 for performing removal operations 40 suitable for machining one or more features 20.

Geometric analysis, in various embodiments, may include a primary filtering step to identify all tools 30 that could possibly be used to machine a given feature 20. Filtering considerations may include basic factors such as cut depth of the feature 20, flute length of the tool 30, stick out of the tool 30, the presence of a reduced shank for clearance, whether the tool 30 is side-cutting and/or center-cutting or otherwise. More advanced approaches may include determining, via geometric analysis, the minimum required and maximum allowable tool diameters for a given feature 20. One method that could be used for this purpose is based on the medial axis transformation (MAT) technique, a commonly employed technique for many types of toolpath calculations. Other suitable techniques could additionally/alternatively be used and the core concept is that a calculation of maximum tools that fit and minimum required diameter is performed. Any tool that satisfies all the basic requirements and has a diameter within the allowed range computed by the geometric analysis is considered a valid possible tool 30 for use on a given feature 20.

In the example of FIG. 3, geometric analysis was used to select a set of tools 30 to be considered in developing the machining strategy 102. Continuing with the example of FIG. 2, the selection process 120 resulted in a set of five tools 31 (T1), 32 (T2), 33 (T3), 34 (T4), 35 (T5) for creating features 21 (F1), 22 (F2), 23 (F3), 24 (F4), 25 (F5), 26 (F6) as shown, where:
T1 is suitable for performing removal operations 40 associated with creating F1, F5, F6;
T2 is suitable for performing removal operations 40 associated with creating F1, F5, F6;
T3 is suitable for performing removal operations 40 associated with creating F1, F2, F3, F6;
T4 is suitable for performing removal operations 40 associated with creating F1, F2, F3, F6; and
T5 is suitable for performing removal operations 40 associated with creating F2 and F4.

Notably, the tool selection process 120 may be configured such that the selected set of tools 30 includes at least one tool 30 or combination of tools 30 suitable for fully machining each feature 20.

Initial tool filtering may result in a potentially large set of tools 30, especially if starting from a complete tool catalog from a supplier. One or more characteristics of many of these valid tools may overlap. For example, several tools 30 may have the same diameter but different lengths (e.g., there may be two different ⅜″ endmills, one with a flute length of 1.5″ and another with a flute length of 0.75″) and/or different corner radius tip geometries. Even when tools 30 do not have the same diameters, they still may be very similar—for example, a ⅜″ tool and a ½″ tool may offer very similar material removal rates in aluminum, but have very different costs. Likewise, two or more valid tools 30 may have the same or similar geometries but different coatings.

While systems and methods of the present disclosure may consider all such valid tools despite such overlap, in various embodiments it may be desirable (e.g., from a computational efficiency standpoint) to further downselect the number of valid tools 30 for consideration. In various embodiments, a secondary tool analysis may be performed in which one tool 30 is selected from amongst a group of two or more tools 30 having one or more overlapping characteristics. In an embodiment, a series of rules comparisons may be utilized to achieve such an effect and the specific rules may be customized to generate specific outcomes per user needs. Example rules may give preference to lower cost tools 30 when they have similar removal rates, to matching coatings to materials, to one tip geometry or another, and the like. Filtering and downselecting the list of valid tools 30 in such manners may provide a smaller, more manageable number of tools 30 for consideration in subsequent steps.

### Identifying Terminal Tools 30 for Roughing and Finishing

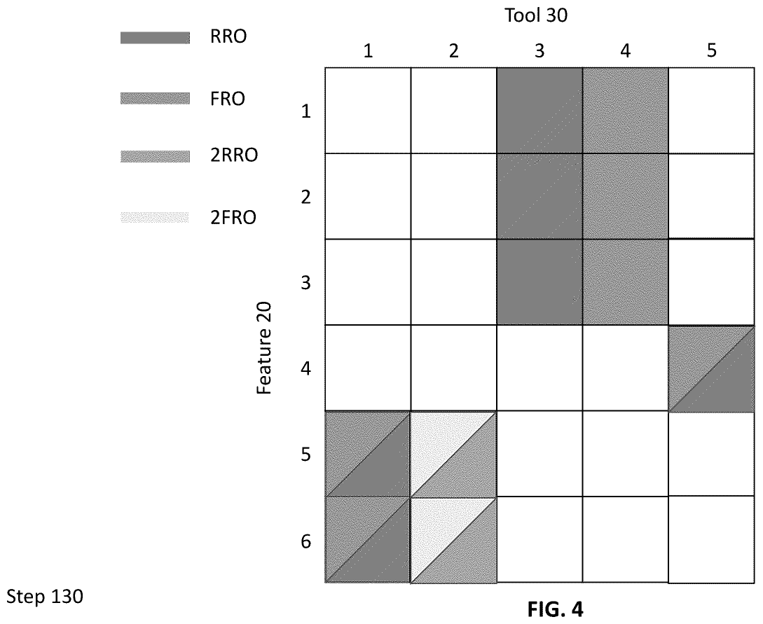

FIG. 4 illustrates a selection of primary and secondary terminal tools 30 in accordance with step 130 of method 100.

From the list of potentially valid tools 30 (whether or not filtered and/or downselected), a smaller subset of tools 30 may be identified as being terminal tools, meaning that the use of any one of these terminal tools 30 is sufficient to fully rough or finish the complete feature 20. In the final machining strategy 102, each feature 20 may be machined with one (and only one) terminal roughing tool 30 and one (and only one) terminal finishing tool 30 out of the set of valid terminal tools 30.

In various embodiments, a medial axis transform (MAT)-based approach may be employed to identify the subset of terminal tools 30. Such an approach may begin by extracting a two-dimensional contour of the geometry of a given feature 20 that includes all critical bounding edges on the inside and outside of the feature 20. A MAT may then be computed for that set of contours using a commercial library or other known methods for computing a MAT. MATs directly provide the minimum/maximum valid diameters that fit inside the contours, and these correspond to the maximum allowable and minimum required tool diameters. Once the minimum/maximum valid diameters are found (whether via a MAT-based approach or other suitable approach), a primary terminal tool 30 may be determined as the first tool 30 in the set that is smaller than the minimum diameter value. If there are any additional tools 30 smaller than the primary terminal tool 30, these may be considered secondary terminal tools. In the event that no tool 30 is smaller than the minimum required diameter then the terminal tool may be determined to be the smallest tool 30 in the valid set.

As shown in FIG. 4, in the running example of the present disclosure, T3 may be a primary terminal roughing tool for roughing removal operations (RRO) 41 associated with machining F1, F2, F3 and T4 may be a primary terminal finishing tool for finishing removal operations (FRO) 42 associated with machining F1, F2, F3. T1 may be both a primary terminal roughing tool and a primary terminal finishing tool for ROOs 41 and FROs 42, respectively, associated with machining F5, F6 and T5 may be both a primary terminal roughing tool and a primary terminal finishing tool for ROOs 41 and FROs 42, respectively, associated with machining F4. T2 may be both a secondary terminal roughing tool and a primary terminal finishing tool for ROOs 41 and FROs 42, respectively, associated with machining F5, F6.

### Identifying Valid Removal Operation Sequences 50

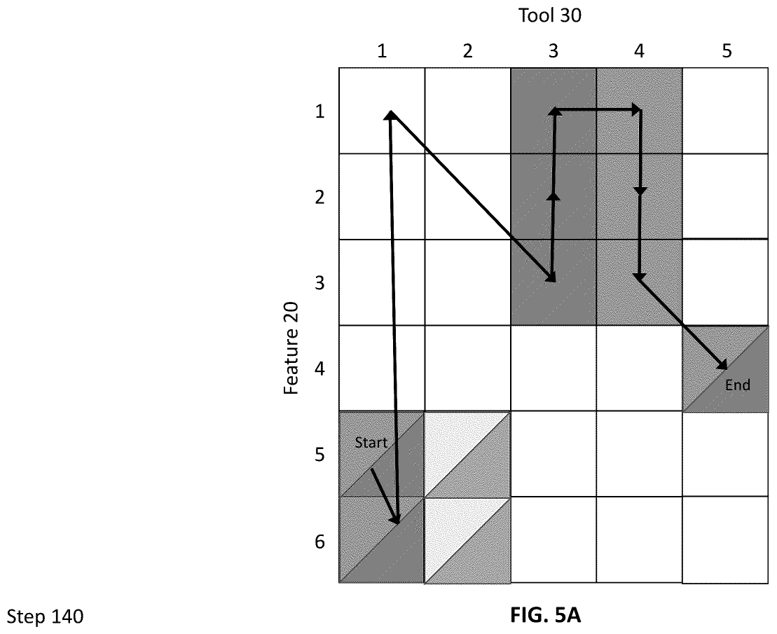

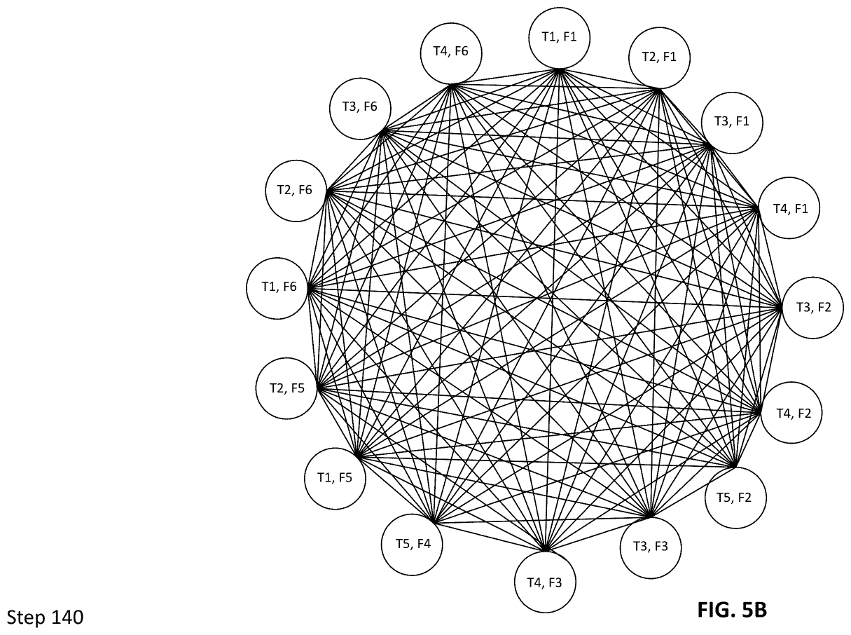

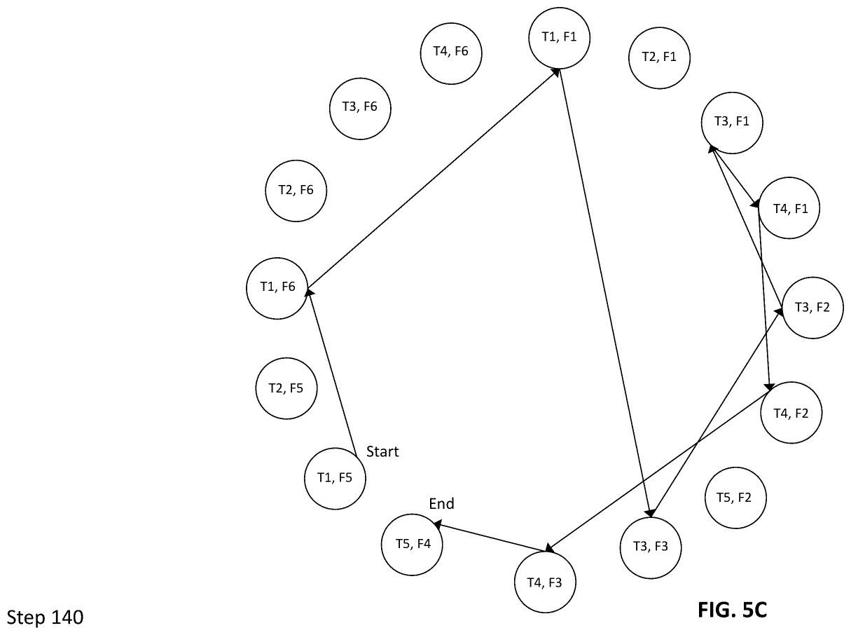

FIG. 5A illustrates a matrix-based approach for identifying valid removal operation sequences 50 to be evaluated during subsequent optimization steps. Shown is an example sequence 50 of removal operations 40 suitable for machining the features 20 using the tools 30 (such example sequence sometimes being referred to as ROS₁ herein).

ROS₁ begins using T1 to perform a first terminal removal operations 41, 42 (RO1) to fully machine F5 and second terminal removal operations 41, 42 (RO2) to fully machine F6. It should be recognized that when a given tool is designated terminal for both roughing and finishing, these two actions may be performed separately and sequentially using different feeds and speeds (i.e., perform terminal roughing 41 then perform terminal finishing 42) yet still be characterized as one removal operation (e.g., RO1 or RO2) herein. T1 is then used to perform a third removal operation 40 (RO3) to partially machine F1, at which point T1 is swapped out for T3 and T3 is used to perform fourth, fifth, and sixth terminal roughing removal operations 41 (RO4, RO5, RO6) to rough out F3, F2, F1, respectively. T3 is then swapped out for T4 and T4 is used to perform seventh, eighth, and ninth terminal finishing removal operations 42 (RO7, RO8, RO9) to finish out F1, F2, F3, respectively. T4 is then swapped out for T5 and T5 is used to perform a tenth terminal removal operation 41, 42 (RO10) to fully machine F4. Note that T2 is not used in ROS1—here, it is conceivable that machining time, as opposed to tool cost, was a priority since T1, while a more expensive tool, has a larger diameter than T2. Of course, in an alternative embodiment, T1 may be skipped in favor of using T2 if tool cost is a priority objective in the optimization process.

While only one removal operation sequence 50 is shown, it should be understood that this is just one of many possible valid sequences 50 and that systems and methods of the present disclosure may be configured to identify all valid sequences 50.

Removal operation sequences 50 can begin with any removal operation 40 (i.e., start in any cell of the matrix) and will be considered valid so long as the resulting removal operation sequence 50 is suitable for machining all features 20. That said, imposing certain constraints can greatly enhance overall computing efficiency by weeding out illogical removal operation sequences 50. For example, in a representative embodiment, one or a combination of the following constraints could be imposed such that each removal operation sequence 50 should:
Not use a tool 30 previously identified as unsuitable for performing a removal operation 40 in connection with a particular feature 20 (i.e., don't go in empty cells of the matrix), as it does not make sense to use an unsuitable tool 30.
Not use a tool 30 to perform the same removal operation 40 more than once (i.e., don't visit any cell in the matrix more than once), as such repetitive removal operation 40 would be a waste of time and cost.
For a given feature 20, perform only one terminal roughing removal operation 41 and only one terminal finishing removal operation 42. Any terminal tool, by definition of it being smaller than the minimum required diameter, will remove all the necessary material. No additional material need be removed by any other terminal tool and hence none should be used. It would, at best, be a waste of time and, at worst, could damage the part by leaving undesirable tool marks.
For a given feature 20, perform an associated roughing removal operation 41 prior to performing an associated finishing removal operation 42. Finishing always comes after roughing (unless a particular tool 30 is suitable for doing both at the same time).

It should be recognized that, in many cases, it may not make intuitive sense to begin with a particular removal operation 40 (i.e., start in a particular cell of the matrix) even if the associated removal operation sequence 50 is valid. For example, starting out in cell (F3, T4) is a highly inefficient starting point since T4 is the smallest tool and will be the slowest to remove material. It would be much more efficient to start with T1. Advantageously, the present system and methods automatically account for this during the subsequent optimization steps via the cost calculations for each removal operation sequence 50, thereby obviating the need for a user to provide guidance as to which removal operation 40 to start with. This can save time, offload the user for other tasks, and even enable a user unskilled in developing machining sequences 102 to utilize the present systems and methods.

FIG. 5B and FIG. 5C illustrate a graph-based approach for identifying valid removal operation sequences 50 to be evaluated during subsequent optimization steps. In the representative graph-based approach shown, each removal operation 40 is characterized as a node representing a given tool/feature tuple from step 130 and the cost of moving from one node to another is characterized as an edge (connector line) representing an edge weight (associated cost). The approach begins by creating an undirected graph connecting various combinations of nodes, and then the above-referenced rules are applied to convert the undirected graph into a series of directed graphs, each representing a removal operation sequence 50. FIG. 5B illustrates an undirected graph corresponding to the matrix of FIG. 4 and FIG. 5C illustrates a directed graph corresponding to the ROS1 shown and described in the context of FIG. 5A.

Notably, the process of selecting an optimized removal operation sequence cannot yet occur though since the cost of each removal operation 40 is sequence-dependent—that is, what happens in preceding removal operations 40 often affects the cost of subsequent removal operations 40, as later described in more detail. As such, the cost of each removal operation sequence 50, including its constituent removal operations 40, is now calculated as set forth below.

### Estimating Cost of Each Valid Removal Operation Sequence 50

Cost can be calculated in many different ways depending, in part, on the particular objective of the optimization process 100. Machining time is often a dominant factor in optimization, with goal of minimizing it and associated costs. Estimated machining time (EMT) 46 for a given removal operation 40 is a function of factors such as the actual removal volume 44 of the removal operation 40 and the material removal rate (MRR) 45 of the tool 30 used to perform the removal operation 40, as later described in more detail.

Other time-based factors may be considered as well, such as tool 30 order (e.g., spot drill before drill, rough before tap/ream) and time required to change tools 30. For example, jumping back and forth between tools 30 in a particular removal operation sequence 50 could add to the overall time required to machine all features 20, compared to an approach in which multiple removal operations 40 are performed across multiple features 20 with a single tool 30 before changing to a different tool 30.

Additionally, or alternatively, cost calculations may account for non-time based factors such as the actual monetary cost of a tool 30, risk factors such as likelihood of tool 30 breakage or tool 30 surface degradation, workpiece 10 holding constraints, or even user preference as to which tools 30 are used.

### Machining Time 46

As previously explained, many of the factors considered when estimating cost are dependent on the particular sequence 50 of removal operations 40 performed. For example, the estimated time to perform a given removal operation 40 often depends, at least in part, on the volume of material to be removed from workpiece 10 during that removal operation 40. Generally speaking, the more material to be removed, the longer the removal operation 40 will take. If preceding removal operations 40 have already removed material that could be removed by the tool 30 to be used in the current removal operation 40, then the current removal operation 40 will take less time to perform than it otherwise would had associated material not been removed in preceding removal operations 40.

Embodiments of the present disclosure may be configured to efficiently account for the effect of material having been removed during preceding removal operations 40 on a subsequent removal operation 40 by calculating a maximum volume of material removable by each tool 30 in connection with each feature 20 with which the tool 30 will be used (the “maximum removal volume” or “MRV” 43) and using these maximum removal volumes 43 to calculate the actual volume of material to be removed during a given removal operation 40 (the “actual removal volume” or “ARV” 44).

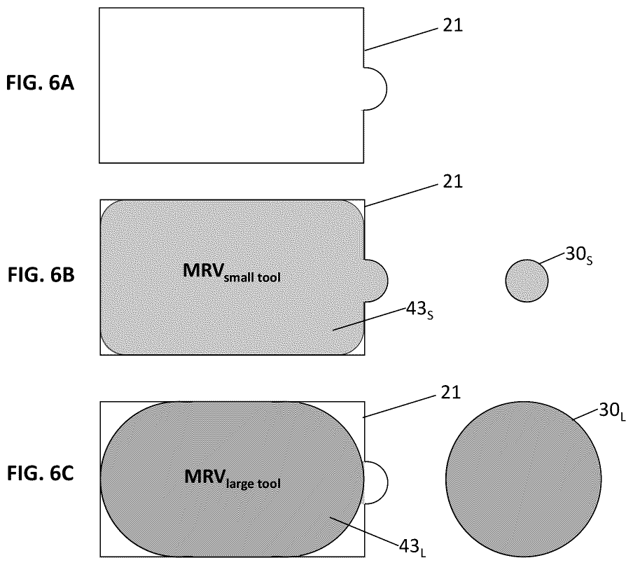

FIGS. 6A-6C illustrate representative maximum removal volumes of different tools 30 for a given feature 20. The maximum removal volume 43 of a given tool 30 for a particular feature 20, in various embodiments, may be calculated via geometric analysis based on the respective dimensions and shapes of the tool 30 and the feature 20. Consider, for example, a largely rectangular pocket 21 is to be machined and that pocket 21 includes a small recess extending outwards from one side, as shown in FIG. 6A. Assuming it is long enough relative to the depth of pocket 21, a small diameter tool 30S such as that shown in FIG. 6B would be able to reach nearly all portions of pocket 21 except for a small portion of the corners. As such, the small diameter tool 30S would have a relatively high maximum removal volume MRV 43S for pocket 21. This MRV 43S is shown in green. Now consider a larger diameter tool 30L such as that shown in FIG. 6C. Assuming it is long enough relative to the depth of pocket 21, the larger diameter tool 30L would not be able to reach as much of pocket 21, including not being able to reach as far into the corners and not being able to reach into the small recess. As such, the large diameter tool 30L would have a lower MRV 43L for pocket 21 than the small diameter tool 30S. This MRV 43L is shown in blue.

In some embodiments, maximum removal volume 43 can be calculated using the medial axis approach earlier described herein, though one of ordinary skill in the art will recognize alternative approaches based on the teachings herein without undue experimentation. In various embodiments, calculations of maximum removal volume 43 for each tool 30 (e.g., step 170) can be calculated in parallel to other steps of the present method 100, as shown back in FIG. 1. Doing so allows for rapid, scalable calculation of cost regardless of the number of features 20 or tools 30. Maximum removal volume 43 values can be stored and later used in connection with calculating the cost of each removal operation sequence 50.

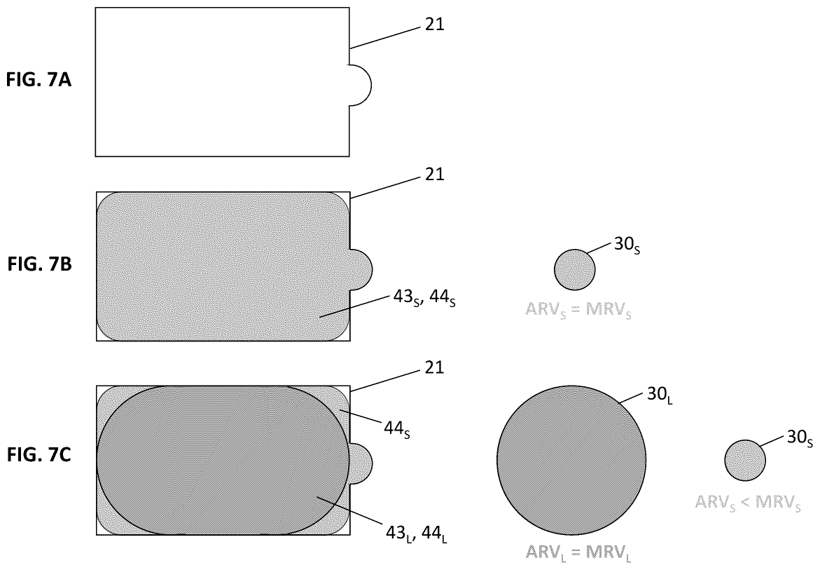

FIGS. 7A-7C illustrate the sequence-dependent nature of actual removal volumes 44 for a given removal operation 40. The actual removal volume 44 of a given removal operation 40 depends on the tool 30 used during the removal operation 40 and any material that has already been removed within the perimeter of that tool's maximum removal volume 43 during preceding removal operations 40. If there have not been any preceding removal operations 40, or if preceding removal operations 40 did not remove material from the subject feature 20 of the current removal operation 40, then the actual removal volume 44 for the current removal operation 40 may be the same as the maximum removal volume 43 of the tool 30 used in the current removal operation 40. For example, in the example of FIG. 7B, the removal operation sequence 50 calls for the small diameter tool 30S to be used on this pocket 21 without any other removal operations 40 having been previously performed on pocket 21. As such, the actual removal volume 44 of the removal operation 40 would be equal to the maximum removal volume 43 of the small diameter tool 30S. Alternatively, if one or more preceding removal operations 40 removed material from the subject feature 20 of the current removal operation 40, and such removal occurred within the bounds of the maximum removal volume 43 of the tool 30 used in the current removal operation 40, there will be less material for the tool 30 of the current removal operation 40 to have to remove. Thus, the actual removal volume 44 of the current removal operation 40 would be less than the maximum removal volume 43 of the tool 30 used in the current removal operation. For example, in the example of FIG. 7C, the small diameter tool 30S will still be used in removal operation 40 associated with pocket 21; however, the large diameter tool 30L is used in a preceding removal operation 40 to remove material falling within the bounds of the maximum removal volume 43S of the smaller diameter tool 30S. With this overlapping material already removed, the small diameter tool 30S need only remove non-overlapping material within the bounds of the maximum removal volume 43S of the smaller diameter tool 30S—that is, material located further inside the corners and in the small recess of pocket 21.

Stated otherwise, actual removal volume 44 can be characterized by the following equation ARV=MRV−Σ_{RO=1}^{nROs}MRV_{RO}, where the maximum removal volume 43 for all prior removal operations 40 associated with the feature 20 are summed and then subtracted from the maximum removal volume 43 of the tool 30 used in the current removal operation 40.

Generally speaking, larger diameter tools 30 will have a higher material removal rate 45 than smaller diameter tools 30, meaning that the material removed by the larger diameter tool 30L would be removed faster than the rate at which the smaller diameter tool 30S could have removed that particular overlapping material volume. Thus, less overall time is required to machine the feature 20 when the larger diameter tool 30L and the smaller diameter tool 30S are used (in that order) compared with using only the smaller diameter tool 30S. In reality though, it takes time to change from the larger diameter tool 30L to the smaller diameter tool 30S in the latter example, so this tool change cost would need to be factored in when determining which of the two approaches is indeed faster overall. Material removal rate 45, in various examples, can be calculated as the depth of cut*width of cut*feed rate.

Machining time 46, in various embodiments, can be estimated for each removal operation 40 in several different ways.

In one approach, machining time 46 can be calculated using a scalar approach in which machining time 46=actual removal volume 44/material removal rate 45, similar to distance=rate×time equations. While this simplified approach may not necessarily capture all of the factors that may go in to the actual time required in real life operations to perform the removal operation, it does confer a reasonable means by which to conduct an apples-to-apples comparison of machining times 46 across various removal operation sequences 50 which, in turn, complements the optimization process since that process is, in various embodiments, based on a comparison of the overall cost of each removal operation sequence 50.

In another approach, actual removal volume 44 and feed/speed data can be passed to a computer aided manufacturing (CAM) engine to compute an actual toolpath 102 (later described) and time estimate. This approach may, in many instances, yield a higher fidelity estimation of machining time 46; however, comes with a significant tradeoff in terms of computing time required.

As later described in more detail, the scalar approach can be used to quickly identify an optimized removal operation sequence 50 without first computing a toolpath 102 for each removal operation sequence, thereby requiring the computation of toolpaths 102 for the optimal removal operation sequence 50 only, at the end of the process rather than many at an intermediate phase of the process. The overall savings in computing time can be very significant and worth the tradeoff in fidelity in many scenarios, thereby providing a technical advantage over prior art systems and methods. Further, the toolpaths 102 of each removal operation 40 of the optimal removal operation sequence 50 can be computed in parallel as later described in more detail, thereby affording additional computational time savings compared with current approaches where toolpaths are calculated in series.

### Other Costs

Additionally, or alternatively, other factors can be factored into determining the cost of each removal operation sequence 50 and its constituent removal operations 40.

Other time-based factors may be considered, such as tool 30 order (e.g., spot drill before drill, rough before tap/ream) and time required to change tools 30. For example, jumping back and forth between tools 30 in a particular removal operation sequence 50 could add to the overall time required to machine all features 20, compared to an approach in which multiple removal operations 40 are performed across multiple features 20 with a single tool 30 before changing to a different tool 30.

Additionally, or alternatively, cost calculations may account for non-time based factors such as the actual monetary cost of a tool 30, risk factors such as likelihood of tool 30 breakage or tool 30 surface degradation, workpiece 10 holding constraints, or even user preference as to which tools 30 are used. Cost may be characterized by any one or combination of such factors and one having ordinary skill in the art will recognize the appropriate factors to consider, and what relative weights to assign each, for a given optimization scenario.

In a representative embodiment, cost may comprise a combination of a removal operation cost component (ROCost), a tool cost component (ToolCost), and a history cost component (HistoryCost).

ROCost may account for factors such as estimated machining time 46, tool-task match score (e.g., a small corner radius is better for roughing than a square end mill), and/or a risk score (e.g., high aspect ratio drilling or milling which risks breaking a tool 30 and getting it stuck in workpiece 10, or tapping vs thread-milling where a broken tap will get stuck but a broken thread mill will not scrap a part). ToolCost may account for non-time-based factors such as tool cost (i.e., the amount of money a particular tool 30 costs to purchase), workpiece 10 holding constraints (e.g., in a situation where there is very light clamping pressure it may be necessary to choose a tool 30 that creates downward force instead of one that creates upward force; endmills which create downward forces can be bad at evacuating chips and would not be used in deep cuts), or user preference (e.g., history using a tool, knowing it gives a nicer surface finish (e.g., face mill vs end mill) or a tool from one manufacturer over the other that are nominally identical but the user knows one performs better in practice). HistoryCost may account for factors such as tool order (e.g., spot drill before drill, rough before tap/ream and overall tool count (e.g., usage of too many drills). It is possible that the fastest overall strategy would be to use six different drills for the six different features 20 in a workpiece 10; however, in practice, many machines have a limit on the number of tools they can hold without requiring machinist intervention to change out tools. Common tool counts can reach 10, 12, 16, 20, or 40 tools. If a user had a full drill index comprised of over 100 different drills then the fastest overall solution that does not exceed the number of tools that can be held in a tool changer may be chosen even if a theoretically faster solution existed that used more tools 30.

Such a cost calculation for a given removal operation sequence 50 could be represented by the following equation: Cost=Σᵢ₌₀^{nROs}ROCostᵢ+Σⱼ₌₀^{nTools}ToolCostⱼ+Σₖ₌₁^{nROs}HistoryCost(RO₁ . . . ROₖ)

### Example Cost Estimation

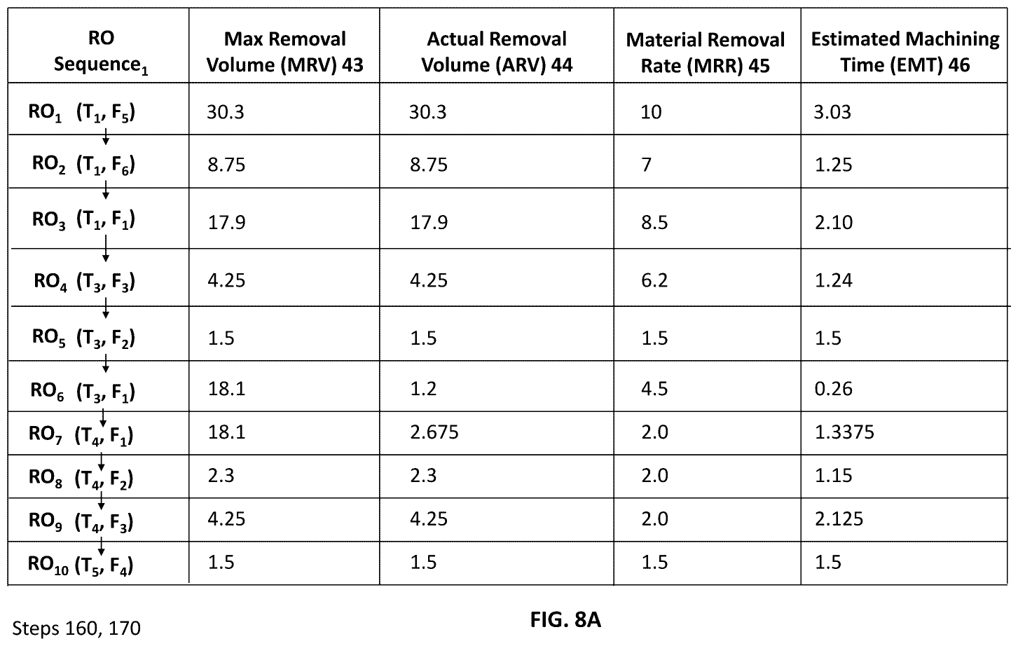

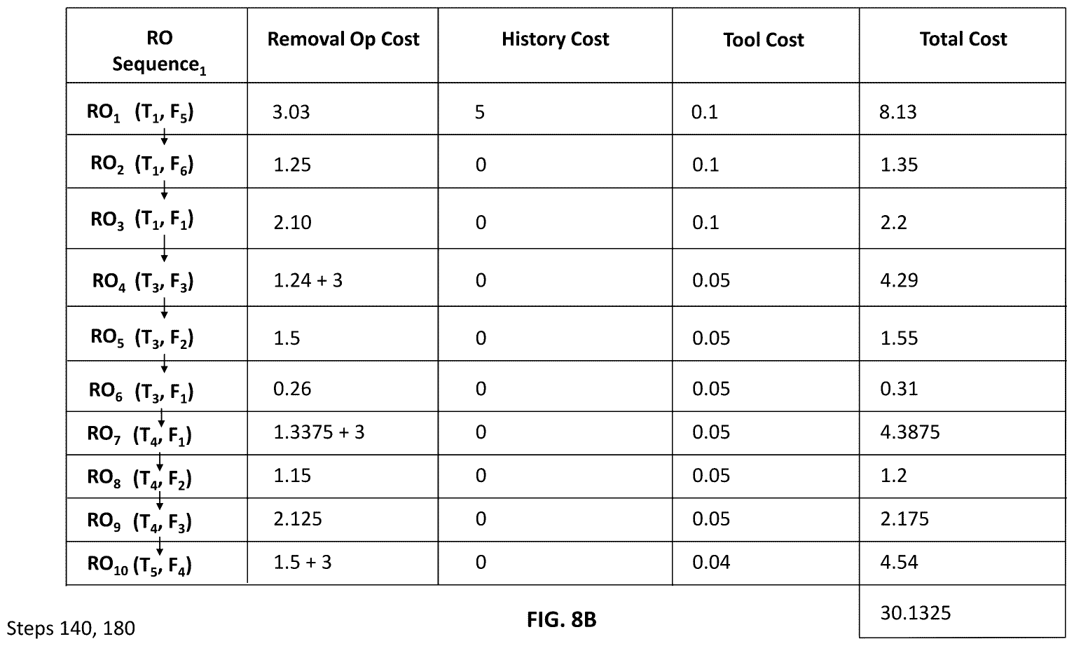

FIG. 8A and FIG. 8B are tables depicting the calculation of machining time 46 and cost, respectively, for an example ROS1 from FIG. 5A and FIG. 5C.

Referring first to FIG. 8A, the maximum removal volume 43 may be computed for each of RO1-10 for ROS1. As previously described, each removal operation 40 represents a removal operation to be performed by a particular tool 30 on a particular feature 20, and the maximum removal volume 43 is the maximum volume that tool 30 could remove from that feature 20. Since maximum removal volume 43 is not a sequence-dependent value, it can be calculated early on in the overall method (e.g., in step 170) using parallel computing resources, as shown in FIG. 1.

Next, the actual removal volume 44 may be computed for each of RO1-10 for ROS1. As previously described, actual removal volume 44 of a given removal operation 40 may be calculated as the maximum removal volume 43 of the given removal operation 40 minus the sum of the maximum removal volumes 43 for all preceding removal operations 40. As this is a sequence-dependent value, it may be calculated after identifying ROS1 as being a valid removal operation sequence 50 for evaluation. The material removal rate 45 may also be computed for each of RO1-10 for ROS1 as previously described.

With actual removal volume 44 and material removal rate 45 known, the machining time 46 required for each removal operation 40 can be estimated using either of the approaches described herein or any other suitable approach. In the table of FIG. 8A, the faster, scalar-based method is shown—that is, EMT 46=ARV 44/MRR 45.

Referring now to FIG. 8B, the cost may be computed for each of RO1-10 for ROS1. As previously described, what exactly the cost represents can vary based on the desired objective of the optimization and the particular parameters considered in connection therewith. In the table of FIG. 8B, cost comprises three components, some time-based and others relating to direct financial costs, machining quality, and the like. Each cost component (i.e., RO Cost, History Cost, and Tool Cost) shown in FIG. 8B was calculated for each of RO1-10 for ROS1 using the methods previously described, and then summed to produce the total cost of each of RO1-10 for ROS1. Then, the total cost of each of RO1-10 were summed to produce the total cost of ROS1.

This process may be repeated for each valid removal operation sequence 50 identified in the preceding steps (e.g., in step 140).

### Identifying an Optimal Removal Operation Sequence 50

The previously described calculations can be performed to estimate the total cost of performing various possible ROSs 50, and an optimal ROS 50 can be identified based on the particular objective of the optimization process 100.

For example, total cost may be the total cost of machining based on the three cost components identified above and the objective of the optimization process 100 is to identify the lowest cost machining strategy 102 for machining the identified features 20 using one or more of the available tools 30. The lowest cost machining strategy 102 here is represented by the ROS 50 with the lowest total cost.

### Method 200 for Automatic Generation and Optimization of Removal Sequences

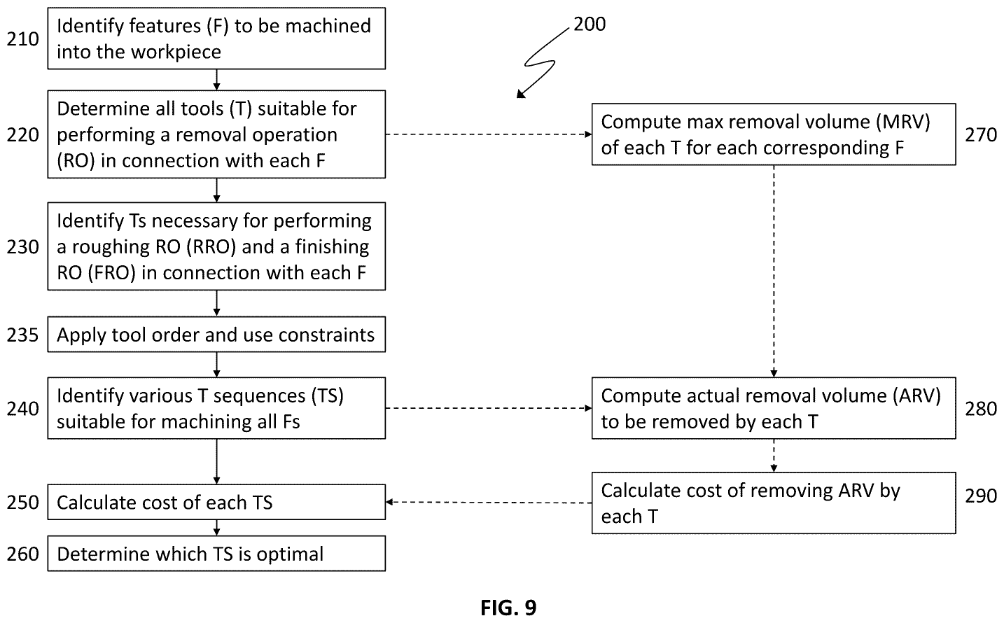

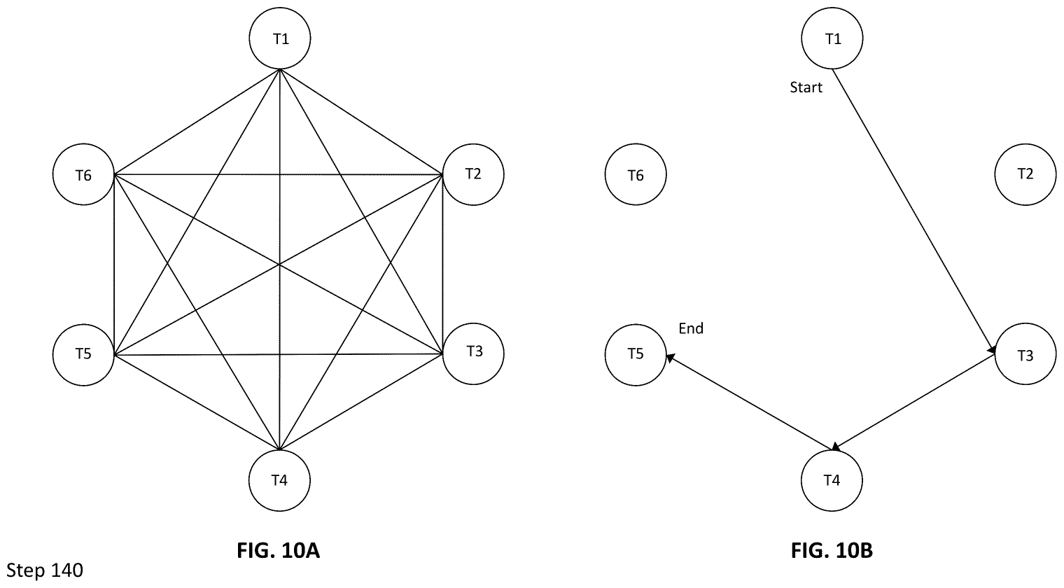

Referring to FIG. 9, in an alternative approach, further practical assumptions can be made to simplify the optimization process. While these assumptions by definition rule out certain machining strategies up front, such that the method may potentially fail to converge on the most optimal solution, the broad applicability of these assumptions across a variety of machining scenarios combined with the massive computational savings they afford, may result in a perfectly acceptable-if not, more advantageous-approach, especially in low volume, high mix machining operations. As such, method 200 can tacitly tradeoff certain optimal machining options to enhance the technological advantage, in terms of computational savings, over other methods when appropriate.

As shown in FIG. 9, steps 210, 220, and 230 of method 200 are largely the same as corresponding steps 110, 120, and 130, respectively, of method 100. At step 235; however, the additional assumptions referenced above may be applied in order to greatly simplify the remaining steps of identifying valid sequences and computing the cost of each for comparison to yield an optimized machining strategy 102.

More specifically, in various embodiments, at step 235 one or more assumptions can be imposed to reduce the analysis from one in which each node represents a tool, feature tuple to one in which each node represents a single tool. In practical terms, in a representative embodiment this can be accomplished by enforcing a tool order a priori and restricting the machining strategy 102 to use each tool 30 only once. Simply stated, the following assumptions are made in a representative embodiment: (i) not all tools 30 must be used, but if they are, they must be used in a prescribed order, and (ii) when a tool 30 is used, all features 20 associated with that particular tool 30 should be milled before moving on to the next tool 30, but such features 20 need not necessarily be milled in any particular order by a given tool 30. Of course, while using a given tool only once is likely to enhance efficiency by reducing time spent changing back and forth between tools, such a constraint need not always be imposed and is merely offered as a representative example of one way to reduce the analysis from one in which each node represents a tool, feature tuple to one in which each node represents a single tool. One having ordinary skill in the art will recognize additional or alternative means to such ends.

By constraining the machining strategies 102 in this manner, the resulting graphs include far fewer nodes (i.e., one per tool 30 at most) compared with the graphs described in the context of method 100. These graphs of method 200 can, in turn, be efficiently solved—for example, via a Steiner Tree approach—by iteratively solving for the shortest path between terminal nodes. This method 200 also reduces the need for parallel computing resources, though such resources can of course be used if the reduced overall computing time justifies the cost of such parallel resources.

FIG. 10A and FIG. 10B illustrate a graph-based approach for identifying valid removal operation sequences 50. Unlike the graph-based approach of FIG. 5B and FIG. 5C, each removal operation 40 is characterized as a node representing a given tool 30 (as opposed to given tool/feature tuple). The cost of moving from one node to another is characterized as an edge (connector line) representing an edge weight (associated cost).

The approach begins by creating an undirected graph connecting various combinations of nodes, and then the above-referenced rules are applied to convert the undirected graph into a series of directed graphs, each representing a removal operation sequence 50. FIG. 10A illustrates a representative undirected graph analogous to the undirected graph of FIG. 5B and FIG. 10B illustrates a representative directed graph analogous to the directed graph of FIG. 5C.

As with method 100, in some embodiments, the optimization process of method 200 may include evaluating the cost of all possible ROSs 50 and selecting the lowest cost ROS while, in other embodiments, the optimization process of method 200 may employ other optimization techniques such as simulated annealing in which the costs of fewer than all possible ROSs 50 are evaluated as the process converges on a suitably optimal ROS 50.

### Method 300—Automatic Generation of Toolpaths

Embodiments of the present disclosure further provide systems and methods for generating toolpaths 102 for the various removal operations 40 in a given removal operation sequence 50. Ordinarily, toolpaths 102 are generated in series, as one typically first determines the state of the workpiece following one removal operation before being able to generate a toolpath for a subsequent removal operation. Stated otherwise, toolpaths are typically sequence-dependent similar to the way removal operations can be, as previously described. Advantageously, the present systems and methods leverage a similar approach based on maximum removal volumes to enable the generation of toolpaths 102 in parallel (i.e., at the same time as one another) rather than in series (i.e., one after another), thereby significantly reducing computing time required to complete a given machining strategy 101 compared with existing methods, as described in more detail below. Further, the approach described herein can not only be used in combination with methods 100 and 200 above to generate toolpaths 102 for an optimal removal operation sequence 50, but also independently to generate toolpaths 102 for any removal operation sequence 50, as described in more detail below.

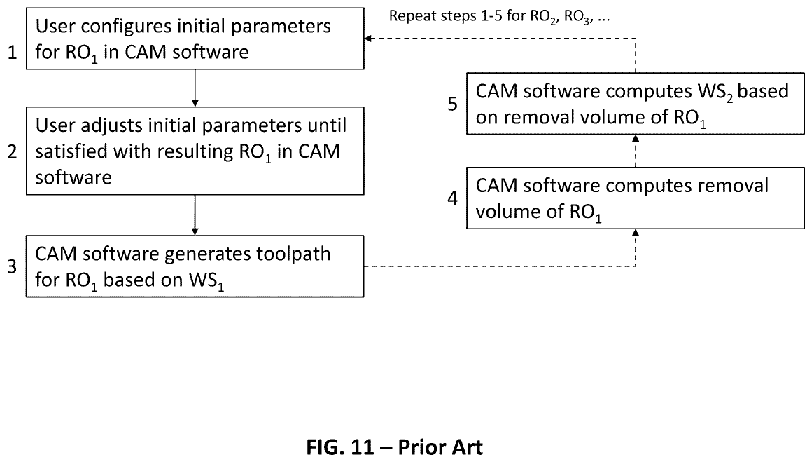

FIG. 11 is a flowchart depicting an existing approach for generating toolpaths and is provided and discussed herein for the sake of comparison with the present systems and methods. In the existing approach, a user of CAM software would manually configure various parameters for the first removal operation that the user decides should be performed. Such parameters may include, for example, selecting a tool, picking a feature to be machined, selecting a specific type of toolpath, and setting the toolpath options. Often this is an iterative process as the user may choose to adjust certain parameters until he/she is satisfied with the configuration in the CAM software. Once satisfied, the user may either (i) direct the CAM software to generate a corresponding toolpath for the removal operation and then repeat for each remaining removal operation, or (ii) configure the parameters for subsequent removal operations and then direct the CAM software to generate corresponding toolpaths for the removal operations. FIG. 11 illustrates the former option.

Regardless of the option chosen, existing CAM software is typically configured to generate toolpaths in series—that is, generate a toolpath for the first removal operation, then generate a toolpath for the second removal operation, and so on. The underlying reason is that the CAM software needs to determine the state of the workpiece (referred to herein as WS) following one removal operation in order to compute a toolpath for a subsequent removal operation. Most compute a removal volume of a preceding removal operation and subtract that from the workpiece stock model to yield the new WS (sometimes called an “in process geometry”) on which the next removal operation will be performed. The WS of the original stock on which the first removal operation is to be performed is referred to herein as WS1, and WS2, WS3, WS4, and so on refer to the WS of the workpiece at such time when the second, third, fourth, and so on removal operations are to be performed. By way of example, subtracting the removal volume of the first removal operation from WS1 will yield WS2, subtracting the removal volume of the second removal operation from WS2 will yield WS3, and so on. This continues one at a time until toolpaths for the full removal sequence have been processed. The CAM software generates the WS on the fly as it completes the associated toolpath for a given removal operation.

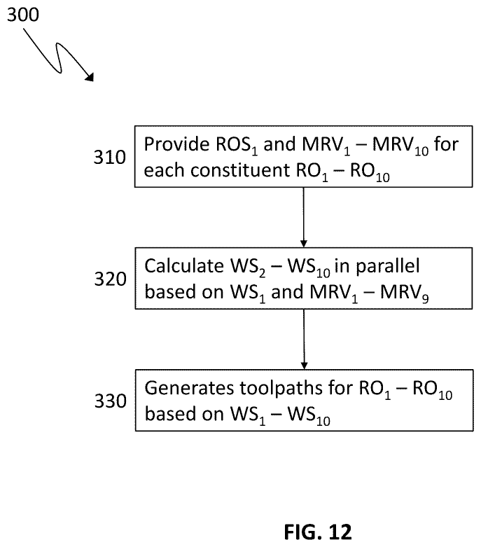

FIG. 12 is a flowchart depicting a representative embodiment of a method 300 for generating toolpaths 102 in parallel, rather than in series, using an optimal removal operation sequence identified using method 100 or 200. Continuing the example of FIG. 8A and FIG. 8B, the optimal removal operation sequence ROS1 comprises ten removal operations RO1-RO10.

In step 310, ROS1 and the maximum removal volumes MRV1-MRV10 associated with RO1-RO10 are provided. Recall that MRV1-MRV10 were previously computed during the ROS optimization process. Of course, in an embodiment, maximum removal volumes MRV1-MRV10 could be computed independently of the optimization process as well; all that is required is a set of matched viable tools and features.

In step 320, WS2-WS10 are calculated in parallel by subtracting from WS1 all MRVs associated with and coming before a given RO. For example:
RO1 starting workpiece is WS1→WS1 is known (original workpiece)
RO2 starting workpiece is WS2→WS2=WS1-MRV1
RO3 starting workpiece is WS3→WS3=WS1-MRV1-MRV2
RO4 starting workpiece is WS4→WS4=WS1-MRV1-MRV2-MRV3
and so on.

Since MRV1-MRV10 were previously computed, WS2-WS10 can be computed in parallel. Once WS2-WS10 are known, all associated toolpaths 102 (TP1-TP10) can be computed in parallel using WS1-WS10.

As noted above, method 300 can be adapted for use independent of methods 100, 200. In such embodiments, the removal operation sequence 50 for which toolpaths 102 will be generated may be one derived from other optimization approaches or one generated by any other means or approach, whether optimal or not. Stated otherwise, toolpaths 102 can be generated for any removal operation sequence desired. Since the MRVs 43 have not yet been calculated (due to using this approach independent of methods 100, 200), step 310 may be adapted to comprise providing an ROS 50 and a new step 315 may be added between steps 310 and 320 in which the MRVs 43 for each RO 40 of the ROS 50 are calculated as previously described herein. The adapted method may then proceed from step 315 to steps 320 and 330, which remain unmodified.

Notably, existing CAM software could be modified to utilize this adapted approach to generate toolpaths in parallel rather than in series and thereby benefit from improved performance. Accordingly, adapted method 300, in some embodiments, may be used without employing methods 100 or 200.

### System 400

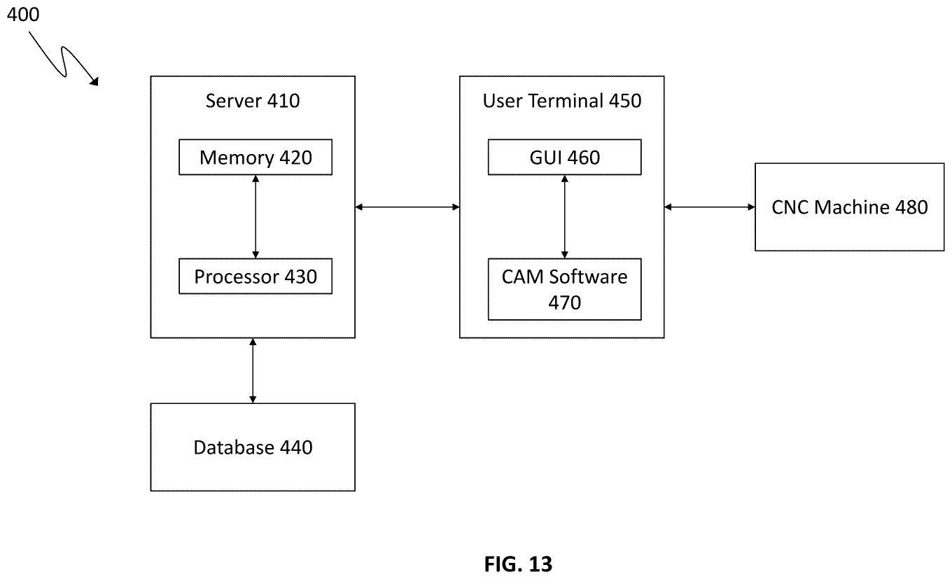

FIG. 13 is a schematic view of a representative system 400 for performing any one or combination of the methods 100, 200, 300 described herein. System 400, in various embodiments, may generally comprise a server(s) 410 comprising memory(s) 420 containing computer-readable instructions for performing methods of the present disclosure and a processor(s) 430 configured to read and execute the computer-readable instructions stored on memory 420. Server 410, in various embodiments, may be a cloud server or other remotely-located server configured to send and receive information, requests, and instructions to and from other components of system 400 via one or more wired or wireless communications links. While the present disclosure refers to memory 420 and processor 430 as being part of a server, it should be recognized that memory 420 and processor 430 may stand alone or be housed in or with any other hardware suitable for permitting memory 420 and processor 430 to store and execute, respectively, computer-readable instructions for performing various methods described herein and thus the present disclosure should not be limited to any one particular hardware embodiment of server 410, memory 420, and processor 430.

System 400, in various embodiments, may further comprise a database(s) 440 configured to store various types of information used in connection with performing the methods of the present disclosure. For example, database(s) 440, in an embodiment, may contain a catalog of available tools 30 (whether on-site, orderable, or otherwise) and their associated specifications such as type, size, material, cutting features, cost, etc. Additionally or alternatively, database 440, in an embodiment, may contain information regarding available CNC machines including associated specifications such as type (e.g., milling, routing, lathe), axes (e.g., 3-axis, 4-axis, 5-axis), table parameters, number of tool holders, etc. In operation, sever 410 may be configured to access information on database 440 via a communications link(s) therebetween to assist with performing methods of the present disclosure, such as when identifying and downselecting tools 30. While database 440 is shown as residing remote from server 410, user terminal 450, and CNC machine 480, it should be recognized that database 440, in various embodiments, may reside locally on or locally networked with server 410, user terminal 450, and CNC machine 480 or any other suitable component(s) of system 400.

System 400, in various embodiments, may further comprise a user terminal(s) 450 comprising a graphical user interface (GUI) 460 and CAM software 470. User terminal 450, in an embodiment, may comprise a desktop or laptop computer, for example, with GUI 460 comprising a display and one or more input devices such as a touchscreen, mouse, keyboard, and/or other peripherals. CAM software 470 may comprise any commercial off-the-shelf CAM software or otherwise suitable for use in connection with generating toolpaths and, optionally, providing instructions (e.g., G-code) to CNC machine 480. While CAM software 470 is shown as locally residing on user terminal 450 it should be recognized that CAM software 470 may sit remotely (e.g., on a cloud server) and interact with user terminal 450 via one or more communications links.

System 400, in various embodiments, may further comprise a CNC machine(s) 480 for machining features 20 into workpieces 10. CNC machine 480 may comprise any commercial off-the-shelf CNC machine or otherwise suitable for such purpose. In various embodiments, CNC machine 480 may be configured to receive instructions for machining a part (e.g., G-code containing toolpaths) from CAM software 470 and/or server 410 and automatically execute such instructions to machine the part without further input from a user.

For case of description, components of system 400 may be referred to herein as singular components (e.g., a processor rather than processor(s)), though it should be recognized that system 400 may comprise any number of each component of system 400 suitable for performing the methods and constituent functions as described in the present disclosure (e.g., multiple processors).

It should be recognized that embodiments of system 400 described herein are merely representative and one of ordinary skill in the art will recognize other embodiments suitable for executing the methods described herein based on the present disclosure without undue experimentation.

The systems and methods described herein provide rapid, scalable technology for automatically generating an optimized strategy for machining a variety of features using a variety of tools. Depending on the assumptions made and options chosen, the resulting optimization strategies can range from “quick and dirty” analyses that provide a user or automated machining device a suitable, if not highly optimized, machining strategy to more refined analyses that may take longer but may produce more accurate and optimized strategies. Each is useful under various circumstances, whether to provide a machinist a “starting point” to work off of and further refine or a strategy that can be implemented largely “as-is” to machine a part to a desired level of refinement. As such, the present systems and methods can greatly improve the efficiency and speed of a variety of machining operations.

What is claimed is:

1. An automated machining system, comprising:
a computer numeric control (CNC) machine; and
at least one processor in electronic communication with the CNC machine, the at least one processor being adapted to obtain computer-executable instructions stored on a non-transitory memory that, when executed by the at least one processor, cause the at least one processor to automatically:
identify, in a computer aided design (CAD) model of a part to be machined, one or more features to be machined into a workpiece to form the part;
determine, from a database of machining tools, for each feature(s) a set of tools suitable for performing a removal operation associated with machining the respective feature;
identify, from each set of tools, those tools necessary for performing a roughing removal operation and a finishing removal operation in connection with each respective feature;
generate, based on utilizing only the tools identified as necessary for performing a roughing removal operation and a finishing removal operation in connection with each respective feature, various sequences of removal operations suitable for machining all of the one or more features;
calculate a cost of performing each removal operation sequence;
determine, based on the calculated cost of each removal operation sequence, which of the removal operations sequences is optimal;
generate, based on the removal operation determined to be optimal, corresponding toolpaths for machining the features into the workpiece; and
provide instructions to the CNC machine for automatically implementing the optimal removal operation sequence and corresponding toolpaths to machine the features into the workpiece to form the part.

2. The automated machining system of claim 1, wherein calculating a cost of performing each removal sequence includes the at least one processor:
computing, for each feature, a maximum removal volume achievable by each tool used to perform a removal operation associated with machining the feature;
computing, for each removal operation sequence, an actual removal volume to be removed during a given removal operation based on the maximum removal volume of the tool(s) used to perform each preceding removal operation in the removal operation sequence; and
calculating a cost of performing each removal operation included in a given removal operation sequence based on the associated actual removal volume.

3. The automated machining system of claim 2, wherein the at least one processor performs the steps of claim 2 in parallel with the following steps of claim 1:
identifying, from each set of tools, those tools necessary for performing a roughing removal operation and a finishing removal operation in connection with each respective feature; and
generating, based on utilizing only the tools identified as necessary for performing a roughing removal operation and a finishing removal operation in connection with each respective feature, various sequences of removal operations suitable for machining all of the one or more features.

4. The automated machining system of claim 2, wherein computing the maximum removal volume of a given tool for a particular feature is performed by the at least one processor via at least one of (i) a geometric analysis based on the respective dimensions and shapes of the tool and the feature and (ii) a medial axis transform (MAT) technique.

5. The automated machining system of claim 1, wherein the cost of performing each removal operation sequence is calculated based at least in part on an estimated machining time required to perform each removal operation of the removal operation sequence.

6. The automated machining system of claim 5, wherein the estimated machining time required is a function of an actual removal volume of each removal operation of the removal operation sequence and a material removal rate of the tool(s) used to perform each removal operation of the removal operation sequence.

7. The automated machining system of claim 1, wherein the at least one processor uses geometric analysis to determine the suitability of a particular tool for performing a removal operation associated with machining a respective feature, the geometric analysis being based at least in part on one or more of a minimum required and maximum allowable tool diameter for the feature, a cut depth of the feature, a flute length of the tool, a stick out of the tool, a presence of a reduced shank on the tool for clearance, and whether the tool is side-cutting and/or center-cutting or otherwise.

8. The automated machining system of claim 1, wherein the at least one processor uses a medial axis transform technique to identify, from each set of tools, those tools necessary for performing a roughing removal operation and a finishing removal operation in connection with each respective feature.

9. The automated machining system of claim 1, wherein generating, based on utilizing only the tools identified as necessary for performing a roughing removal operation and a finishing removal operation in connection with each respective feature, various sequences of removal operations suitable for machining all of the one or more features includes identifying possible combinations of removal operations that satisfy the following constraints: (i) not using a given tool to perform the same removal operation more than once, (ii) for a given feature, performing only one terminal roughing removal operation and only one terminal finishing removal operation, and (iii) for a given feature, performing an associated roughing removal operation prior to performing an associated finishing removal operation.

10. The automated machining system of claim 1, wherein generating, based on utilizing only the tools identified as necessary for performing a roughing removal operation and a finishing removal operation in connection with each respective feature, various sequences of removal operations suitable for machining all of the one or more features includes identifying possible sequences of tool use that satisfy the following constraints: (i) not all tools must be used but if they are they must be used in a prescribed order, and (ii) when a tool is used, all features associated with that particular tool should be machined before moving on to the next tool in the tool sequence, but such features need not necessarily be machined in any particular order by a given tool.

11. The automated machining system of claim 1, wherein generating, based on the removal operation determined to be optimal, corresponding toolpaths for machining the features into the workpiece includes:
computing a maximum removal volume achievable by each tool used to perform a removal operation of the optimal removal operation sequence;
determine, in parallel, the state of the workpiece at each of the removal operations by subtracting, from a state of the workpiece at the first removal operation, all of the computed maximum removal volumes associated with and coming before the respective removal operation; and
computing, in parallel, the toolpaths based on the corresponding determined state of the workpiece.

12. The automated machining system of claim 1, further comprising:
generating, based on the set of tools determined as being suitable for performing a removal operation associated with machining a respective feature, a matrix of cells or undirected graph of nodes depicting each valid tool-feature combination; and
identifying, in the matrix or undirected graph, those cells or nodes corresponding to the tools identified as being suitable for performing a roughing removal operation and a finishing removal operation in connection with each respective feature.

13. The automated machining system of claim 12, further comprising, to the extent a matrix of cells was generated:
selecting a first cell in which to begin, the first cell having been identified as being suitable for performing a roughing removal operation associated with a first feature; and
connecting the first cell in series with one or more additional cells until the connected cells collectively represent the performance of a roughing removal operation and a finishing removal operation for each feature, each additional cell (i) being neither the first cell nor any other cell selected prior to the selection of such cell, and (ii) having been identified as being suitable for either (a) performing a roughing removal operation in connection with a feature for which a roughing removal operation has not yet been performed, or (b) performing a finishing removal operation in connection with a feature for which a roughing removal operation has already been performed,
wherein the connected cells represent a removal operation sequence suitable for machining all of the one or more features.

14. The automated machining system of claim 12, further comprising, to the extent an undirected graph of nodes was generated, converting the undirected graph into a series of directed graphs, the directed graphs representing the various sequences of removal operations suitable for machining all of the one or more features.

15. The automated machining system of claim 14, wherein converting the undirected graph into the series of directed graphs comprises:
selecting a first node at which to begin, the first node having been identified as being suitable for performing a roughing removal operation associated with a first feature; and
connecting the first node in series with one or more additional nodes until the connected nodes collectively represent the performance of a roughing removal operation and a finishing removal operation for each feature, each additional node (i) being neither the first node nor any other node selected prior to the selection of such node, and (ii) having been identified as being suitable for either (a) performing a roughing removal operation in connection with a feature for which a roughing removal operation has not yet been performed, or (b) performing a finishing removal operation in connection with a feature for which a roughing removal operation has already been performed,
wherein the connected nodes represent a removal operation sequence suitable for machining all of the one or more features.

16. A system for automatic generation and optimization of machining strategies, the system comprising:
at least one database containing information regarding one or more available machining tools;
at least one processor; and
non-transitory memory containing computer-readable instructions that, when executed by the at least one processor, cause the at least one processor to:
access the information regarding the one or more machining tools on the at least one database;
determine, based on the accessed information, a set of tools suitable for performing a removal operation associated with machining a feature to be machined into a workpiece;
identify, from each set of tools, those tools necessary for performing a roughing removal operation and a finishing removal operation in connection with each respective feature;
generate, based on utilizing only the tools identified as necessary for performing a roughing removal operation and a finishing removal operation in connection with each respective feature, various sequences of removal operations suitable for machining the feature;
calculate a cost of performing each removal operation sequence; and
determine, based on the calculated cost of each removal operation sequence, which of the removal operations sequences is optimal.

17. The system of claim 16, wherein information regarding one or more available machining tools includes any one or combination of a type, size, material, cutting features, and cost of each machining tool.

18. The system of claim 16,
wherein the one or more databases further contain information regarding one or more available computer numeric control (CNC) machines, and
wherein (i) determining the set of tools suitable for performing a removal operation includes excluding, based on the information regarding the one or more available CNC machines, any tools not suitable for use with the one or more available CNC machines, (ii) generating the various sequences of removal operations includes excluding, based on the information regarding the one or more available CNC machines, removal operations not suitable for use with the one or more available CNC machines, and/or (iii) calculating the cost of performing each removal operation sequence is a function of at least the information regarding the one or more available CNC machines.

19. The system of claim 18, wherein the information regarding one or more available CNC machines includes any one or combination of a type, number of axes, table parameters, number of tool holders, and feed/speed capability of each of the one or more available CNC machines.

20. The system of claim 16, wherein calculating a cost of performing each removal sequence includes the at least one processor:
computing, for each feature, a maximum removal volume achievable by each tool used to perform a removal operation associated with machining the feature;
computing, for each removal operation sequence, an actual removal volume to be removed during a given removal operation based on the maximum removal volume of the tool(s) used to perform each preceding removal operation in the removal operation sequence; and
calculating a cost of performing each removal operation included in a given removal operation sequence based on the associated actual removal volume.

21. The system of claim 20, wherein the at least one processor performs the steps of claim 20 in parallel with the following steps of claim 16:
identifying, from each set of tools, those tools necessary for performing a roughing removal operation and a finishing removal operation in connection with each respective feature; and
generating, based on utilizing only the tools identified as necessary for performing a roughing removal operation and a finishing removal operation in connection with each respective feature, various sequences of removal operations suitable for machining all of the one or more features.

22. The system of claim 20, wherein computing the maximum removal volume of a given tool for a particular feature is performed by the at least one processor via at least one of (i) a geometric analysis based on the respective dimensions and shapes of the tool and the feature and (ii) a medial axis transform (MAT) technique.

23. The system of claim 16, wherein the cost of performing each removal operation sequence is calculated based at least in part on an estimated machining time required to perform each removal operation of the removal operation sequence.

24. The system of claim 23, wherein the estimated machining time required is a function of an actual removal volume of each removal operation of the removal operation sequence and a material removal rate of the tool(s) used to perform each removal operation of the removal operation sequence.

25. The system of claim 16, wherein the at least one processor uses geometric analysis to determine the suitability of a particular tool for performing a removal operation associated with machining a respective feature, the geometric analysis being based at least in part on one or more of a minimum required and maximum allowable tool diameter for the feature, a cut depth of the feature, a flute length of the tool, a stick out of the tool, a presence of a reduced shank on the tool for clearance, and whether the tool is side-cutting and/or center-cutting or otherwise.

26. The system of claim 16, wherein the at least one processor uses a medial axis transform technique to identify, from each set of tools, those tools necessary for performing a roughing removal operation and a finishing removal operation in connection with each respective feature.

27. The system of claim 16, wherein generating, based on utilizing only the tools identified as necessary for performing a roughing removal operation and a finishing removal operation in connection with each respective feature, various sequences of removal operations suitable for machining all of the one or more features includes identifying possible combinations of removal operations that satisfy the following constraints: (i) not using a given tool to perform the same removal operation more than once, (ii) for a given feature, performing only one terminal roughing removal operation and only one terminal finishing removal operation, and (iii) for a given feature, performing an associated roughing removal operation prior to performing an associated finishing removal operation.

28. The system of claim 16, wherein generating, based on utilizing only the tools identified as necessary for performing a roughing removal operation and a finishing removal operation in connection with each respective feature, various sequences of removal operations suitable for machining all of the one or more features includes identifying possible sequences of tool use that satisfy the following constraints: (i) not all tools must be used but if they are they must be used in a prescribed order, and (ii) when a tool is used, all features associated with that particular tool should be machined before moving on to the next tool in the tool sequence, but such features need not necessarily be machined in any particular order by a given tool.

29. The system of claim 16, further comprising:
generating, based on the set of tools determined as being suitable for performing a removal operation associated with machining a respective feature, a matrix of cells or undirected graph of nodes depicting each valid tool-feature combination; and
identifying, in the matrix or undirected graph, those cells or nodes corresponding to the tools identified as being suitable for performing a roughing removal operation and a finishing removal operation in connection with each respective feature.

30. The system of claim 29, further comprising, to the extent a matrix of cells was generated:
selecting a first cell in which to begin, the first cell having been identified as being suitable for performing a roughing removal operation associated with a first feature; and
connecting the first cell in series with one or more additional cells until the connected cells collectively represent the performance of a roughing removal operation and a finishing removal operation for each feature, each additional cell (i) being neither the first cell nor any other cell selected prior to the selection of such cell, and (ii) having been identified as being suitable for either (a) performing a roughing removal operation in connection with a feature for which a roughing removal operation has not yet been performed, or (b) performing a finishing removal operation in connection with a feature for which a roughing removal operation has already been performed,
wherein the connected cells represent a removal operation sequence suitable for machining all of the one or more features.

31. The system of claim 29, further comprising, to the extent an undirected graph of nodes was generated, converting the undirected graph into a series of directed graphs, the directed graphs representing the various sequences of removal operations suitable for machining all of the one or more features.

32. The system of claim 31, wherein converting the undirected graph into the series of directed graphs comprises:
selecting a first node at which to begin, the first node having been identified as being suitable for performing a roughing removal operation associated with a first feature; and
connecting the first node in series with one or more additional nodes until the connected nodes collectively represent the performance of a roughing removal operation and a finishing removal operation for each feature, each additional node (i) being neither the first node nor any other node selected prior to the selection of such node, and (ii) having been identified as being suitable for either (a) performing a roughing removal operation in connection with a feature for which a roughing removal operation has not yet been performed, or (b) performing a finishing removal operation in connection with a feature for which a roughing removal operation has already been performed,
wherein the connected nodes represent a removal operation sequence suitable for machining all of the one or more features.

33. A system for automatic generation of toolpaths for machining one or more features into a workpiece, the system comprising:
at least one processor; and
non-transitory memory containing computer-readable instructions that, when executed by the at least one processor, cause the at least one processor to:
compute a maximum removal volume achievable by one or more tools used to perform a removal operation associated with machining the one or more feature into the workpiece;
determine, in parallel, a state of the workpiece at each removal operation of a removal operation sequence to be performed to machine the one or more features into the workpiece by subtracting, from a state of the workpiece at the first removal operation, all of the computed maximum removal volumes associated with and coming before the respective removal operation; and
computing, in parallel, toolpaths for machining the one or more features into the workpiece in accordance with the removal operation sequence based on the corresponding determined state of the workpiece at each removal operation.

34. The system of claim 33, wherein computing the maximum removal volume of a given tool for a particular feature is performed by the at least one processor via at least one of (i) a geometric analysis based on the respective dimensions and shapes of the tool and the feature and (ii) a medial axis transform (MAT) technique.
